(19) United States
(12) Patent Application Publication
(10) Pub. No.: US 2019/0311034 A1
(43) Pub. Date: Oct. 10, 2019

(54) MULTIPLE NETWORK DEVICE TYPE SUPPORT USING VARIABLE MAPPING

(71) Applicant: NetBrain Technologies, Inc., Burlington, MA (US)

(72) Inventors: Lingping Gao, Burlington, MA (US); Guangdong Liao, Burlington, MA (US); Peng Zhao, Burlington, MA (US); Yuan Zhao, Burlington, MA (US); Chaoxiang Cheng, Burlington, MA (US)

(73) Assignee: NetBrain Technologies, Inc., Burlington, MA (US)

(21) Appl. No.: 16/375,297

(22) Filed: Apr. 4, 2019

Related U.S. Application Data
(60) Provisional application No. 62/652,566, filed on Apr. 4, 2018.

(51) Int. Cl. G06F 17/27; H04L 12/24

(52) U.S. Cl. CPC G06F 17/2705; H04L 41/22

(57) ABSTRACT

A system is disclosed for network management automation of multiple network devices from different vendors. Network devices from different vendors may include different variables, but a variable mapping of those different variables can be used for providing a single task that will perform the same function network devices from different vendors.

### PRIORITY

This application claims priority to U.S. Provisional App. No. 62/652,566, filed on Apr. 4, 2018, entitled “MULTIPLE NETWORK DEVICE TYPE SUPPORT USING VARIABLE MAPPING IN A NETWORK MANAGEMENT SYSTEM,” the entire disclosure of which is hereby incorporated by reference.

### BACKGROUND

In the modern computer age, businesses rely on an electronic network to function properly. Networks are getting more and more complex but network engineers still depend on the traditional methods and tools, such as the text-based command-line interface (CLI), to manage their networks. To troubleshoot a network problem or to simply verify if a network functions, a network engineer still needs to manually log in to each of the network devices and issue a CLI command to gather the data, manually parse and analyze each of the output for key data, and manually eliminate each of the possible problem causes. With text-based CLI as the primary method for troubleshooting a network problem, a network professional usually needs to repetitively execute the same CLI commands and decode key data from the command output many times for many network devices. This process is error-prone, strenuous and time consuming. For each of the enterprises across the vast network world, this process may be repeated again and again, without any benefit from learning past lessons or from other people's experiences.

To further complicate this already tangled process, many vendors and models of network hardware devices that exist in today's network, are providing different sets of CLI commands which output many different formats of data information. It is difficult, if not impossible, for a network engineer to simplify this process by writing a simple executable program to retrieve, parse and analyze the output data of each of these different devices. It is even more challenging to require a network engineer to master a programming language in a short time, and apply such skills in a reliable manner. There is a need to find a universal solution to be able to parse and analyze data outputs of different devices from various vendors.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates a block diagram of an example network system.

FIG. 2 illustrates a block diagram of an exemplary network manager.

FIG. 3 illustrates an example screenshot of a parser.

FIG. 4 illustrates one example of a screenshot of an analyzer.

FIG. 5 is an interface for defining an alert.

FIG. 6 is a screenshot of a web-based GUI.

FIG. 7 illustrates an interface for two decision branches.

FIG. 8 is an example of a variable mapping between variables from different vendors.

FIG. 9 illustrates an interface for parser selection.

FIG. 10 illustrates an interface in which the source can be filtered.

FIG. 11 illustrates an interface for Qapp selection.

FIG. 12 illustrates an interface for adding a mapping.

FIG. 13 illustrates an example interface for deleting a mapping.

FIG. 14 illustrates an interface in which missing records are shown.

### DETAILED DESCRIPTION

By way of introduction, the disclosed embodiments relate to systems and methods for network management automation for multiple network devices from different vendors. Network devices from different vendors may include different variables, but a mapping from those different variables is used for providing an automation task that will function similarly across the different variables for devices from different vendors. As described below, the network management automation may be through the NetBrain QAPP (“Qapp”) system. The Qapp system is further described with respect to U.S. Pat. Nos. 9,374,278, 9,438,481, U.S. Pat. Pub. No. 2015/0156077, U.S. Pat. Pub. No. 2016/0359687, and U.S. Pat. Pub. No. 2016/0359688, the entire disclosure of each of which is hereby incorporated by reference. With a variable mapping, the Qapp system can run network automation tasks on devices from different vendors.

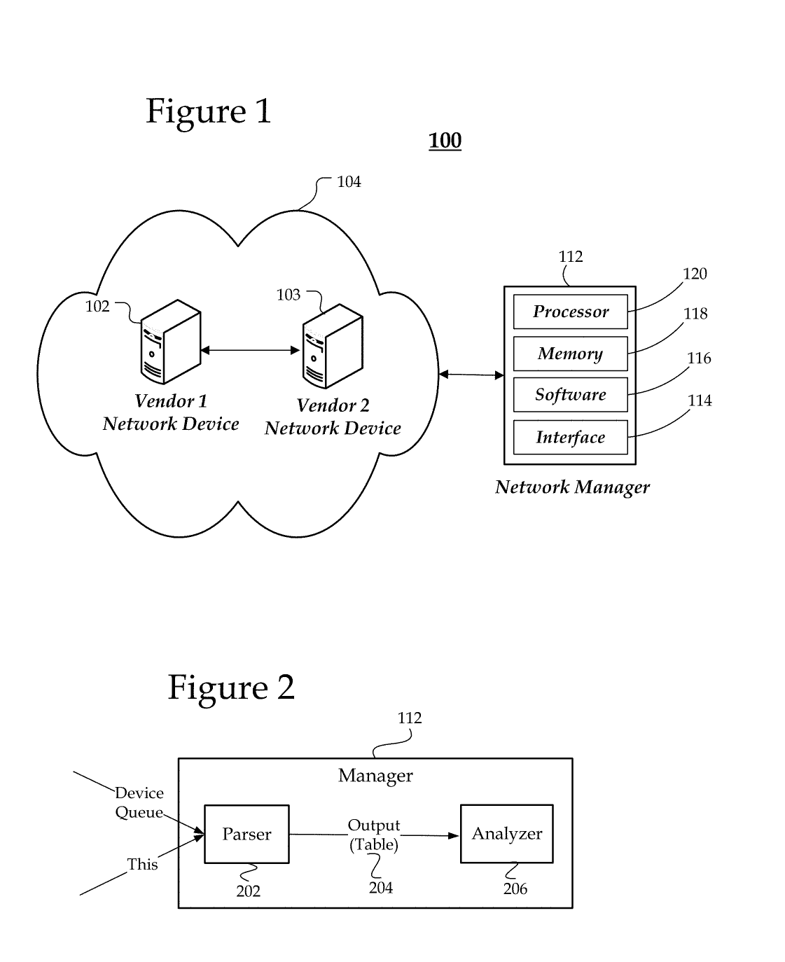

FIG. 1 illustrates a block diagram of an example network system 100. The system 100 may include functionality for managing network devices. The network system 100 may include any number of network devices that are managed. FIG. 1 illustrates two example network devices 102, 103 from different vendors that belong to a network 104.

The devices 102, 103 may be any computing or network device, which belong to the network 104, such as a data center or enterprise network. Examples of devices 102, 103 include, but are not limited to, routers, access points, databases, printers, mobile devices, personal computers, personal digital assistant (“PDA”), cellular phones, tablets, other electronic devices, or any network devices. The devices 102, 103 may be managed by the network manager 112.

The network manager 112 may be a computing device for monitoring or managing devices in a network, including performing automation tasks for the management, such as with a Qapp. In other embodiments, the network manager 112 may be referred to as just a Qapp when performing a Qapp network management task. Alternatively, the network manager 112 may be referred to as a variable mapper when performing the variable mapping and for the operation of a Qapp using the variable mapping. The network manager 112 is further illustrated in FIG. 2. The network manager 112 may include a processor 120, a memory 118, software 116 and a user interface 114. In alternative embodiments, the network manager 112 may be multiple devices to provide different functions and it may or may not include all of the user interface 114, the software 116, the memory 118, and/or the processor 120.

The user interface 114 may be a user input device or a display. The user interface 114 may include a keyboard, keypad or a cursor control device, such as a mouse, or a joystick, touch screen display, remote control or any other device operative to allow a user or administrator to interact with the network manager 112. The user interface 114 may communicate with any of the network devices (e.g. 102, 103), and/or the network manager 112. The user interface 114 may include a user interface configured to allow a user and/or an administrator to interact with any of the components of the network manager 112. The user interface 114 may include a display coupled with the processor 120 and configured to display an output from the processor 120. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing data.

The processor 120 in the network manager 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program (i.e. software 116), such as code generated manually (i.e., programmed). The software 116 may include the Qapp system and tasks that are performed as part of the management of the network devices. Specifically, the variable mapping may be implemented as part of a Qapp stored in software, such as the software 116.

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the software 116 or the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal, so that a device connected to a network can communicate voice, video, audio, images or any other data over a network. The user interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a (computer) network, including but not limited to the network 104. For example, the network manager 112 may be coupled with the devices 102, 103 through a network. Accordingly, any of the components in the system 100 may include communication ports configured to connect with a network. The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

FIG. 2 illustrates a block diagram of an exemplary network manager 112. As described above, the network manager 112 may perform a network management task (e.g. a Qapp). The Qapp system provides for network management automation by collecting and analyzing live data from multiple network devices at one time rather than logging into multiple network devices, one by one, via command line instructions. The Qapp takes a group of network devices as an input and performs various analyses to generate a specific output based on the network tasks. For example, one type of Qapp can monitor the operational status of network devices and create alerts if the operational status of a respective network device is outside of an expected range. As is known, a Qapp can monitor a set of operating parameters such as CPU usage, memory usage, and interface packet drops of network devices. Any operating parameters which can be retrieved via SNMP, CLI or API can be monitored by a Qapp.

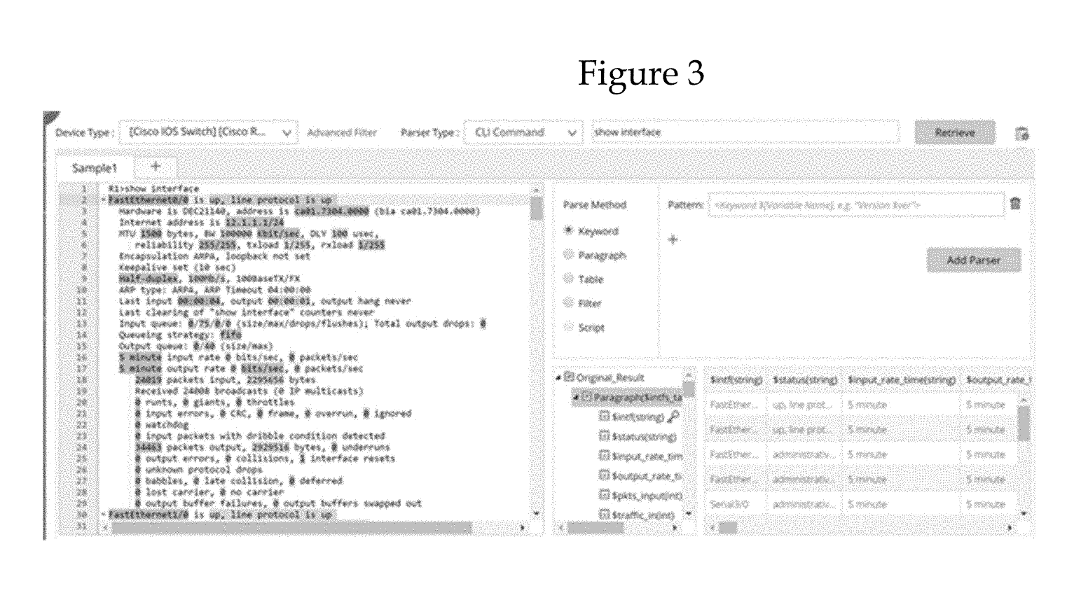

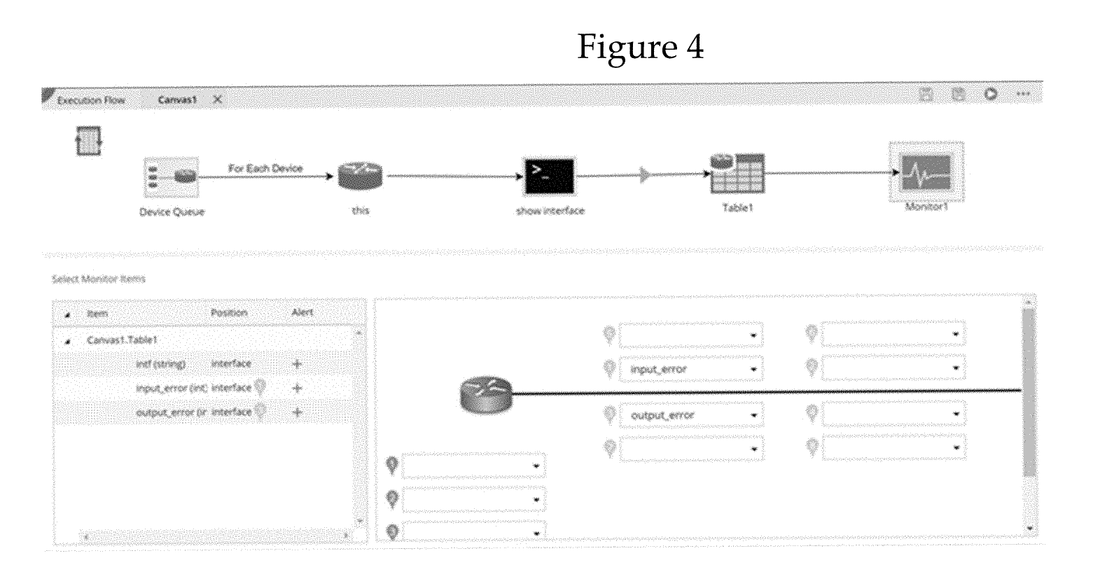

FIG. 2 illustrates that the network manager 112 includes a parser 202 that receives inputs. The parser 202 may define a method to retrieve and parse data. The output 204 of a parser are one or more variables. The variables can be a single value (such as CPU usage) or a table (e.g. interface input errors). The parser 202 may parse a CLI command, such as shown in FIG. 3. For example the screenshot shown in FIG. 3 is for the CLI command “show interface” of a CISCO IOS switch, the output 204 may be a table with a row corresponding to a device interface and a column corresponding to the interface properties or status such as interface name, input rate time, input errors, etc.

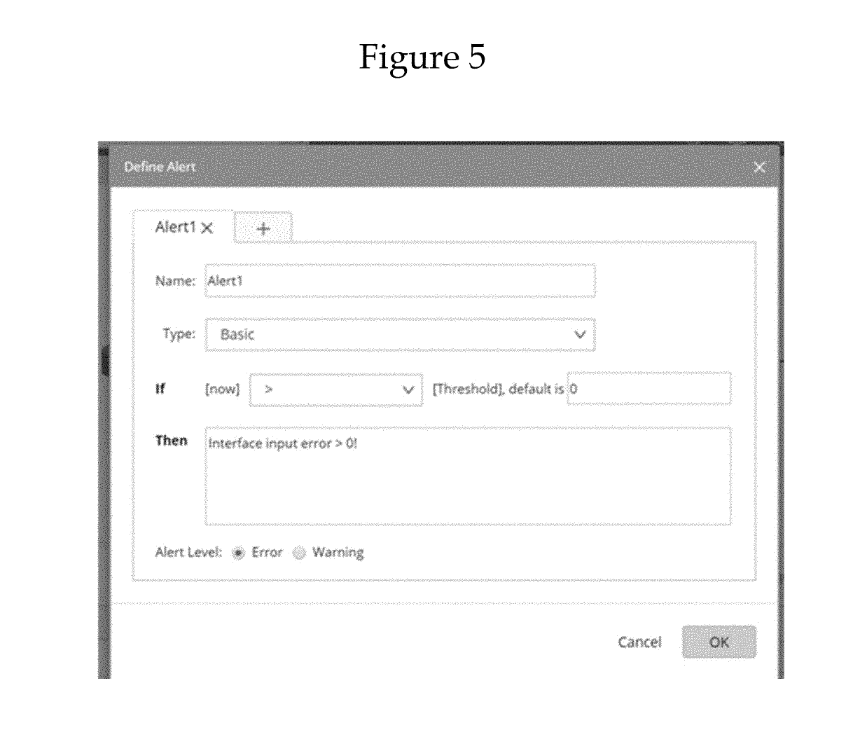

In FIG. 2, the output 204 from the parser 202 is input into an analyzer 206. The analyzer 206 analyzes the variables of the parser 202. In one example, the analyzer 206 displays the variable value in the map and creates an alert if a certain condition occurs. FIG. 4 illustrates one example of a screenshot of an analyzer 206. The example in FIG. 4 is “if a device CPU usage is higher than 90% or an interface input error is not zero.” The interface errors (variable $input_error and $output_error) are displayed along the links, i.e., the representations of connections between devices in the network, in the map. Alerts may be defined for these errors. FIG. 5 is an interface for defining an alert.

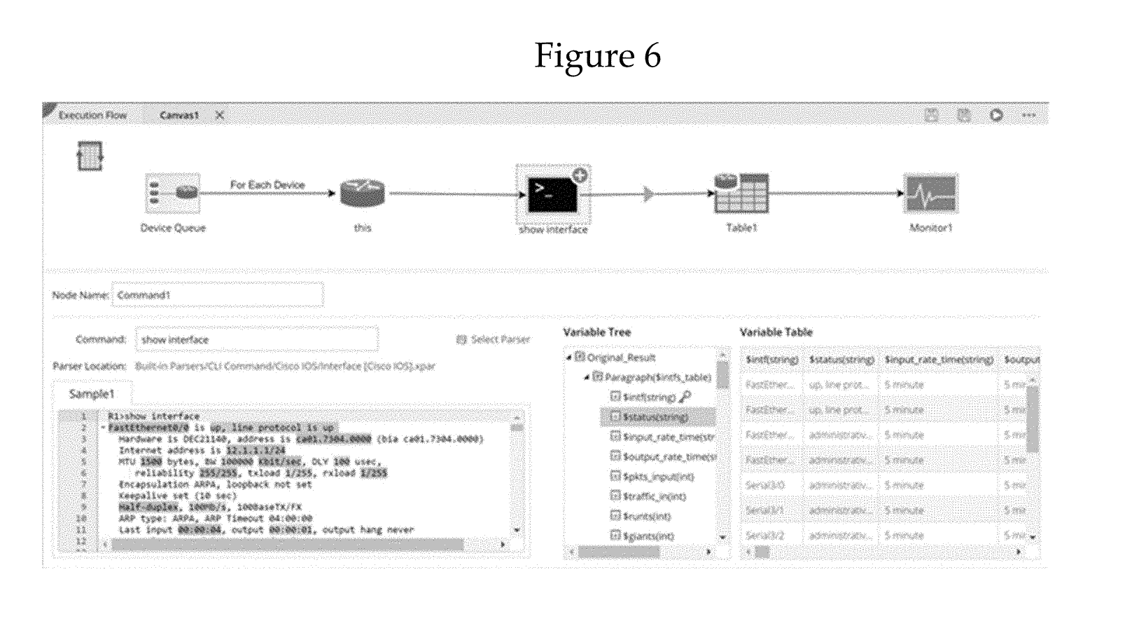

FIG. 6 is a screenshot of a web-based graphical user interface (GUI), to facilitate the user creating a Qapp. A Qapp may be executed within a map and in one example, the Qapp may take all devices visibly drawn in the map as the input. FIG. 6 is a GUI that may be similar to the network manager 112 in that the first two nodes of FIG. 6 (Device Queue and This) define the input of the Qapp as shown in FIG. 2 (inputs to the parser 202). The “show interface” node may be the parser 202 and the output 204 from FIG. 2 is shown as Table 1 in FIG. 6. The parser itself can be defined outside of the Qapp and the Qapp can refer to an independent parser or can create its own parser. The last node shown in FIG. 6 as “Monitor1” is the analyzer 206.

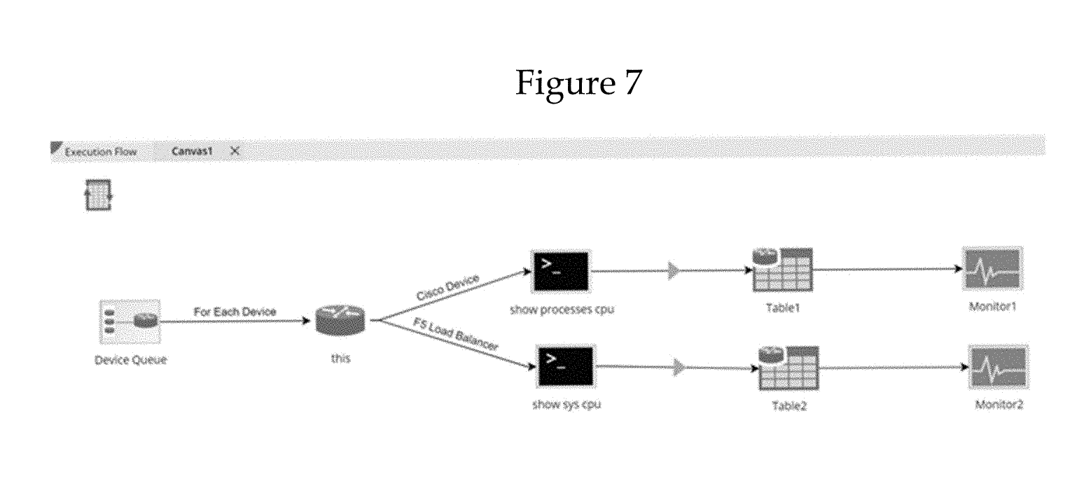

There are many hundreds of vendors of network devices, including but not limited to CISCO, JUNIPER, HEWLETT-PACKARD, CHECKPOINT, etc. Accordingly, a challenge of managing a network of devices involves the disparate operations and commands for devices from each vendor. From the perspective of an end user, a Qapp should work for different vendors' devices. To write a Qapp applicable to all mainstream vendors, however, may require a mapping of like variables from the different vendors. For the same task of obtaining a device's CPU usage, different vendors may have different CLI commands and their own variables for the usage. In that example, a CISCO device may use the CLI command “show process CPU” to retrieve average CPU usage for CISCO devices while an F5 load balancer may use the CLI command “show sys cpu” to retrieve the average CPU usage for an F5 load balancer device. Accordingly, a network task or Qapp to obtain CPU usage must consider the different commands required for every unique device if the single network task or Qapp is to be applied across a network. To create a Qapp to monitor the CPU usage for a network that has both CISCO and F5 devices, one must incorporate two decision branches where each branch has its own parser and analyzer depending on the vendor as illustrated in FIG. 7. To extend a Qapp for other vendors such as JUNIPER, ARISTA, CHECKPOINT, etc. would require even more branches to be added unless variable mapping is performed such that a single Qapp would apply to devices from multiple vendors.

The mapping of variables from devices of different vendors may be referred to as a data dictionary. The mapping may include a mapping of both the different commands and the different variables from multiple vendors. Using the variable mapping, a Qapp that is written for a single vendor may be expanded to cover other vendors when using the variable mapping.

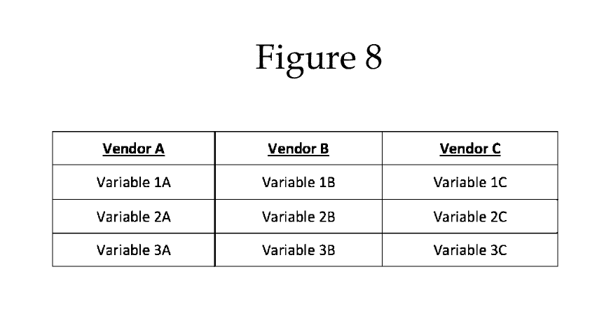

FIG. 8 is an example of a variable mapping between variables from different vendors. FIG. 8 illustrates three unique vendors, vendor A, vendor B, and vendor C. Variable 1 may be a variable, such as CPU usage, but as represented in FIG. 8, variable 1 may be unique for each of the different vendors and be slightly different (i.e. 1A, 1B, 1C). Likewise, the other variables from different vendors are unique but may be mapped together as shown by each row of the mapping in FIG. 8. This correspondence may be used in a Qapp. For example, a Qapp written with variable 1A that is run on a device for Vendor B, would then be modified to use variable 1B (corresponding to Vendor B) rather than variable 1A. The variable mapping may be between different parsers for different vendors.

Using variable CPU usage measurement as an example, it may be established that the variable $cpu defined in the parser “show process cpu” for CISCO devices and the variable $current_cpu_usage defined in the parser “show system cpu” for F5 Load Balancer may be similar or even have the same meaning. In other words, from the perspective of the end user and a data analysis node (e.g. analyzer 206), these two variables may be either equal or substantially similar. This equivalence can be presented as: “show process cpu” (Cisco).$cpu=“show system cpu”(F5).$current_cpu_usage. This mapping allows for the variables to be replaced depending on the vendor. A variable of a parser of one vendor can be mapped to multiple variables of parsers for multiple other vendors by referring to the variable mapping. In the CPU usage measurement example, if a CHECKPOINT device uses the command “opstat os-f cpu” to retrieve the cpu usage, then that variable can be mapped to the CISCO and F5 variables discussed above. Specifically, a mapping may be created for the CPU usage variables between the three parsers for CISCO, F5 and CHECKPOINT: “show process cpu” (Cisco).$cpu=“show system cpu” (F5).$current_cpu_usage=“opstat os-f cpu”(Checkpoint).$cpu_usage.

A Qapp can be created only for a single vendor, but when using the variable mapping, that Qapp may be run for different vendors. As discussed above, the Qapp may refer to a parser and analyzer (as described with respect to FIG. 2) for the variables of the parser. The Qapp may be executed for a set of devices in a network of devices where the devices may be of different vendors and/or types. If a device belongs to the vendor originally defined by the Qapp, the Qapp may be executed as defined. Otherwise, if the device belongs to a different vendor, the system may check whether a variable mapping exists between this vendor and the original vendor for each of the variables defined in the Qapp. If such a mapping exists, the system will call the mapped parser to retrieve the mapped variable and execute the data analysis by the analyzer.

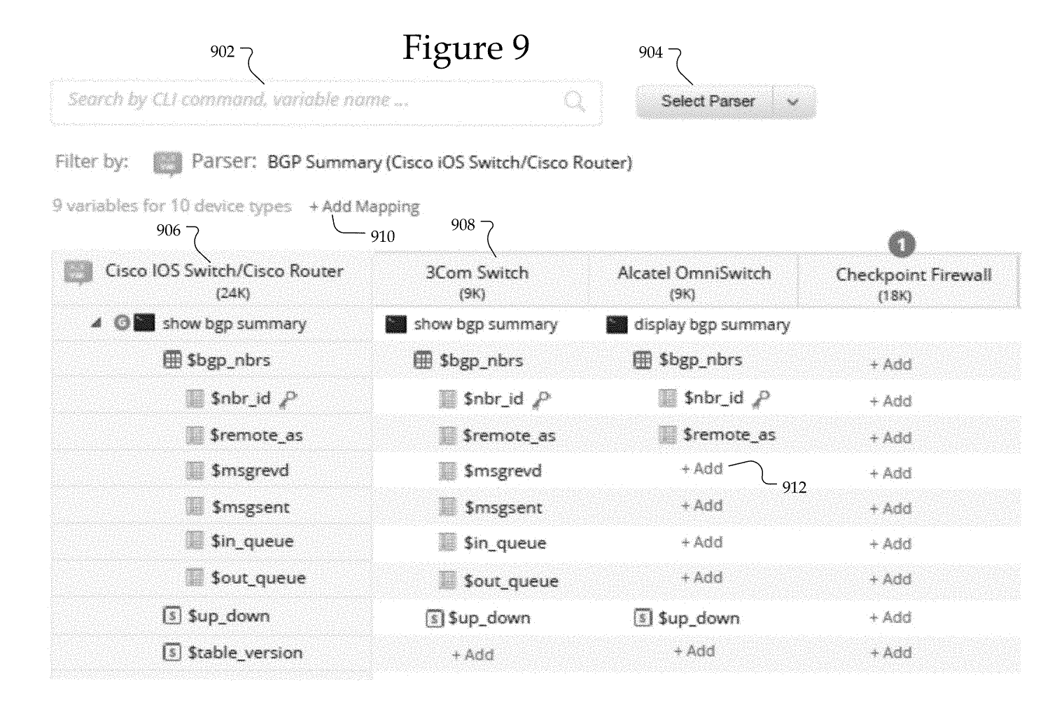

FIG. 9 illustrates an interface for parser selection. The user can select a parser to view all variable mappings defined for this parser. All existing mappings for each variable of this parser are listed. If no mapping exists, an add button is displayed to allow a user to add the mapping. Only vendors or device types existing in one's network may be displayed here. A user of the interface shown in FIG. 9 can search 902 by a CLI command or by variable name. The search may be limited to a particular parser 904 that can be selected by the user. In the example of FIG. 9, the parser is listed as “BGP Summary (Cisco iOS Switch/Cisco Router).” That parser is shown in the first column 906 with a listing of variables below that parser. There are three other parsers shown, which may correspond to different devices or correspond to a particular manufacturer: a 3Com Switch 908, an Alatel OmniSwitch and a Checkpoint Firewall. Where a variable mapping exists between these parsers there is shown a corresponding variable for that parser. When a variable does not exist, such as the variable 912, which is missing, the user can “add” a variable for that parser that corresponds to the variables on that row. As shown in FIG. 9, the last parser does not include variables that correspond with the other variables shown.

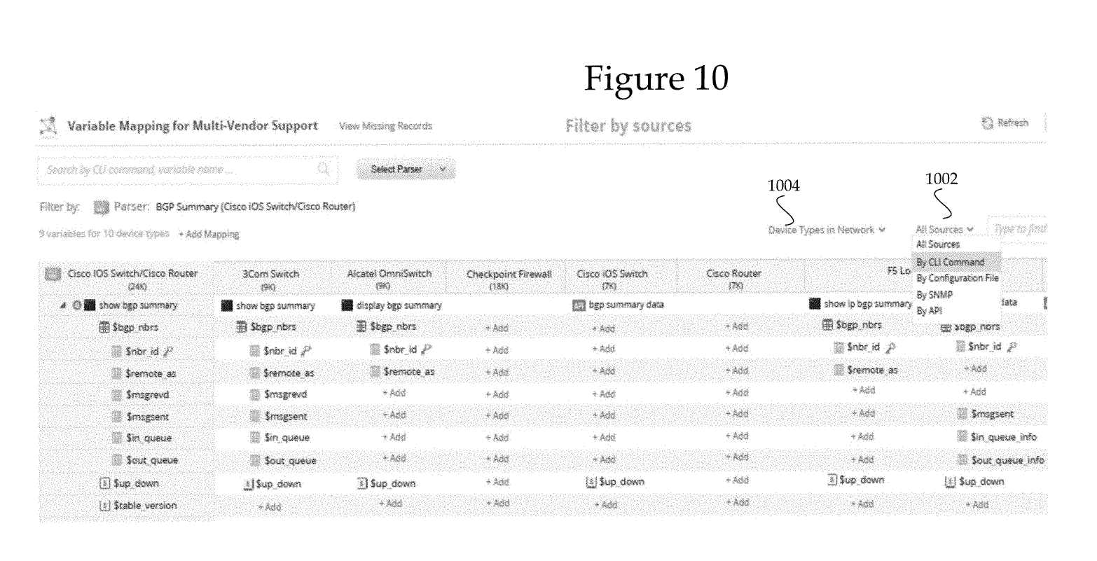

FIG. 10 illustrates an interface in which the source 1002 can be filtered. In the example shown in FIG. 10, the source 1002 may include CLI Command, Configuration File, SNMP, API, or All Sources, as the example sources for searching by. Specifically, the mapping may be limited in the interface based on the selected source 1002. In another embodiment, the mapping may be narrowed by sorting based on the device type 1004. Specifically, the user can view the variable mappings based on the device type. The default may be a listing of only the device types that are currently present in the network.

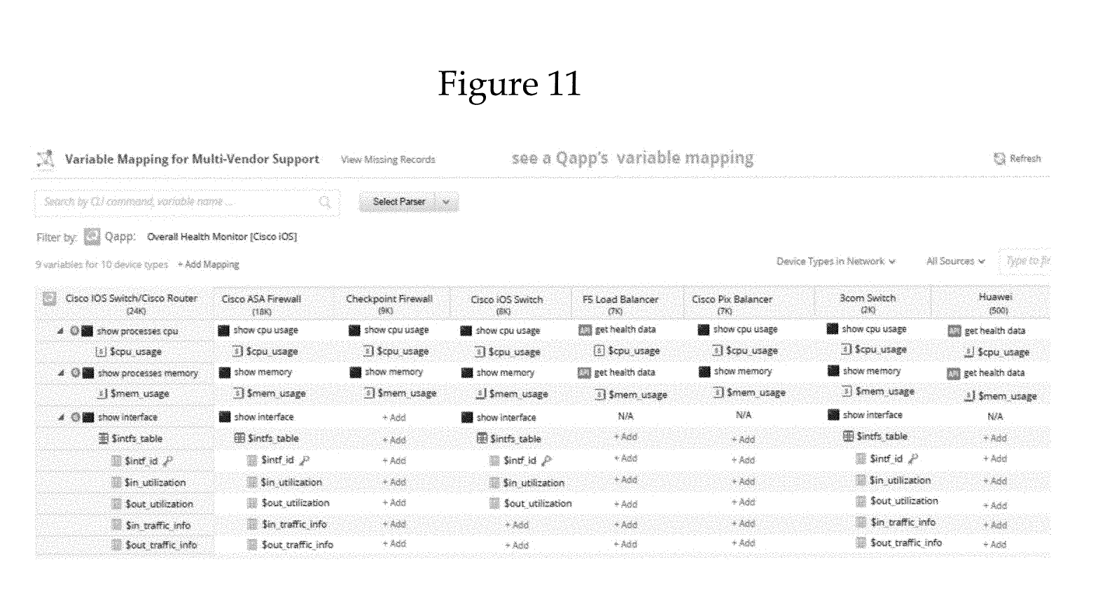

FIG. 9 illustrated how the parser may be selected (i.e. 904 in FIG. 9). In addition, a particular Qapp may also be selected for viewing the mapping of variable relevant to that Qapp. Specifically, selecting a particular Qapp can show the variable mapping for that Qapp as shown in FIG. 11. Specifically, FIG. 11 illustrates the selection of the Qapp “Overall Health Monitor [Cisco iOS].” The user can select a Qapp to view all mappings of all variables used by that Qapp. In one embodiment, the mappings of the variables used in a data analysis node (i.e. analyzer) of a Qapp may be listed rather than all variables in a parser.

In another embodiment, the search function may also allow for searching by variable. Accordingly, a search for a particular variable may show a list of the devices/parsers where that variable appears.

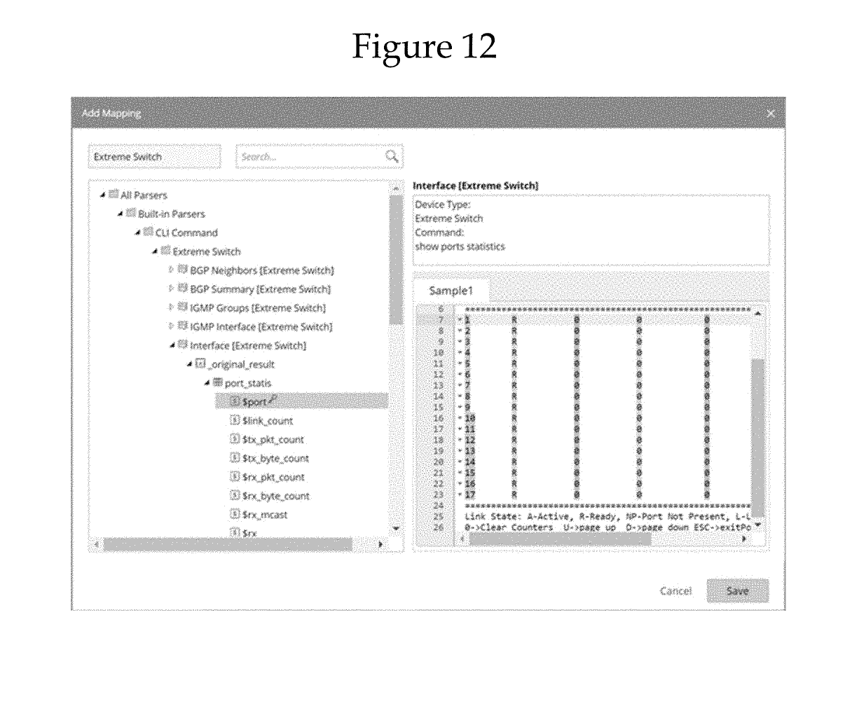

Referring back to FIG. 9, where a variable for a particular device/parser was missing there may be option to add 912 a corresponding variable. From the view of variable mappings (either filtered by the parser or by Qapp), a user may click the add button to add a new variable mapping. The mapping can only be added between two variables that are of the same type, such as a Single Variable that has only a single value, a table variable, or a table column. FIG. 12 illustrates an interface for adding a mapping. In one embodiment, FIG. 12 is the interface upon clicking the “Add Mapping” button 910 from FIG. 9. The mapping process allows for the mapping of any number of variables from any number of the multiple vendors.

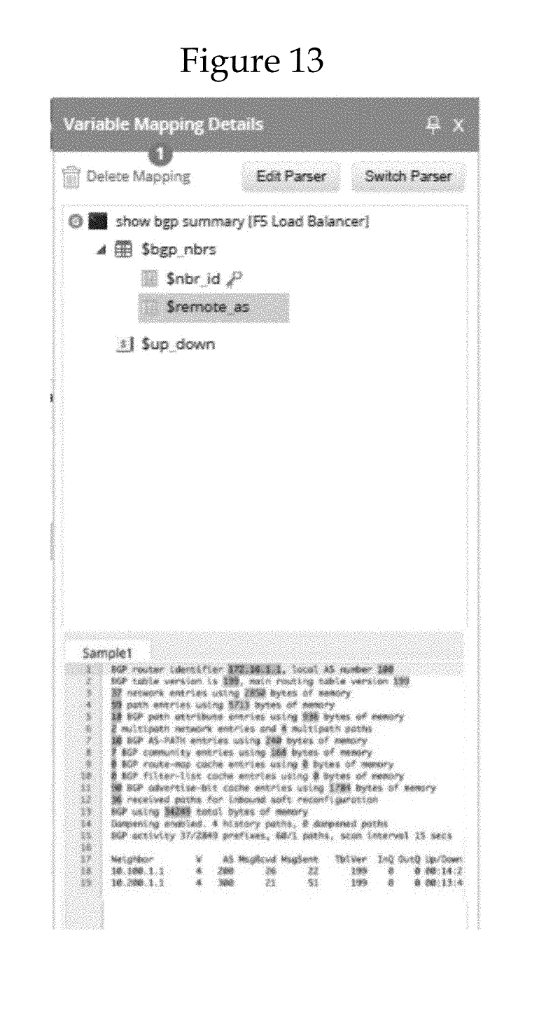

In addition to adding a variable mapping, a variable mapping may also be deleted. FIG. 13 illustrates an example interface for deleting a mapping. Specifically, the variable “$remote_as” is the selected variable that is being deleted.

Both the parsers and the variable mapping may be exported from the interface. Likewise, the parsers and the variable mapping may be imported into the interface. The export function may be used as a backup mechanism and the import function may be used for troubleshooting to return a network to a previously working state.

A Qapp may be executed against a list of devices, for example, all devices of a network map. If the current device, against which the Qapp is being executed, belongs to the device type originally defined by the Qapp, the Qapp may be executed as defined. Here “device type” may refer to both the vendor and/or the type of device. In one example, a Cisco IOS switch is one type of device while a Cisco ASA Firewall is another. Otherwise, if the device belongs to a different device type, the system executing the Qapp will check whether a mapping exists between this device type and the original device type (i.e. the device type for which the Qapp was written). If such a mapping exists, the system will call the mapped parser to retrieve the mapped variable and execute the corresponding data analysis with the analyzer. If such other mapping does not exist (i.e. there is no mapping for another device type), the system will record information in a table called “missing variable mapping.”

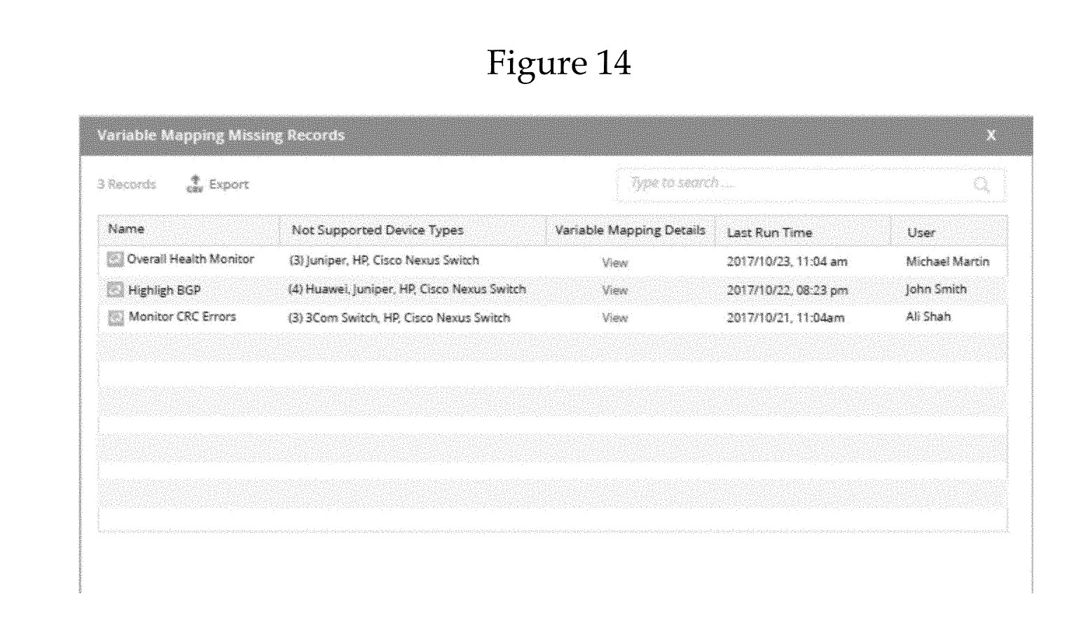

FIG. 14 illustrates an interface in which missing records are shown. The missing variable mappings may be one function of the interfaces shown above. There may be a list of all variables missing that can be used as guidance for the user to add more variable mapping in order to obtain information from other devices in the network. In one example, the “missing variable mapping” may be shown as a table that displays the missing mapping for all executed Qapps. A user may view all missing variable mappings for any particular Qapp.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for network management comprising:
a first network device from a first vendor and corresponding with a first set of variables;
a second network device from a second vendor and corresponding with a second set of variables, wherein at least some of the first set of variables are different from the second set of variables; and
a network manager configured to manage a network that includes the first network device and the second network device, wherein the network manager further comprises:
a parser for outputting one or more variables from either the first set or the second set; and
an analyzer including a variable mapper configured to map the outputted one or more variables between the first set and the second set, wherein the analyzer performs an analysis of both the first network device and the second network device.

2. The system of claim 1, wherein the first vendor is a first manufacturer and the second vendor is a second manufacturer.

3. The system of claim 1, wherein the analyzer generates an output corresponding to a particular task.

4. The system of claim 3, wherein the particular task is associated with first network device.

5. The system of claim 4, wherein the particular task can be run on the second network device when using the variable mapper.

6. The system of claim 4, wherein the particular task comprises a Qapp.

7. The system of claim 1, wherein the first set of variables or the second set of variables comprises a CPU usage, memory usage, interface packet drops, interface input errors, or other network monitoring results.

8. The system of claim 1, wherein the variable mapper comprises a listing of vendors and associated variables.

9. The system of claim 1, wherein the parser and the analyzer are configured to handle the variables from either the first network device or the second network device.

10. A graphical user interface comprising:
a listing of different device types;
a listing of variables from each of the different device types;
a mapping that shows how each of the variables from the different device types correspond with one another; and
a network management task that runs for any of the different device types by referencing corresponding variables from the mapping.

11. The interface of claim 10, further comprising:
a parser selection for selecting a parser.

12. The interface of claim 11, wherein the parser corresponds with a particular device type.

13. The interface of claim 10, wherein the mapping displays an indication of a missing variable for a particular device type.

14. A method for network management, the method comprising:
monitoring a plurality of network devices, wherein the plurality of network devices comprises a first network device from a first vendor and a second network device from a second vendor;
executing a network management task using one or more variables associated with the first vendor;
mapping the one or more variables with variables associated with the second vendor; and
executing the network management task with the variables associated with the second vendor.

15. The method of claim 14, wherein the network management task comprises a Qapp.

16. The method of claim 14, wherein the mapping comprises a user interface displaying a listing of vendors and associated variables.

17. The method of claim 14, wherein the first vendor is a first manufacturer and the second vendor is a second manufacturer.

18. The method of claim 14, wherein the executing of the network management task provides information about the network devices connected to a network.

19. The method of claim 14, wherein the variables comprise at least one of a CPU usage, memory usage, interface packet drops, interface input errors, or other network monitoring results.
